(19) United States
(12) Patent Application Publication
(10) Pub. No.: US 2014/0215573 A1
(43) Pub. Date: Jul. 31, 2014

(54) SYSTEM AND METHOD FOR APPLICATION ACCOUNTS

(71) Applicant: DESIRE2LEARN INCORPORATED, Kitchener (CA)

(72) Inventor: Brian Cepuran, Kitchener (CA)

(73) Assignee: Desire2Learn Incorporated, Kitchener (CA)

(21) Appl. No.: 13/756,029

(22) Filed: Jan. 31, 2013

(51) Int. Cl. G06F 21/31

(52) U.S. Cl. CPC G06F 21/31
USPC 726/4

(57) ABSTRACT

System and methods of controlling computing application interactions with an electronic learning platform are described herein. The systems and methods may involve creating application accounts for computing applications, receiving a request for a computing application to interact with an electronic learning platform, determining whether an application account corresponds to the computing application of the request, and determining whether the requested interaction is permitted based the permissions and the settings of any account for the respective computing application.

### FIELD

The embodiments described herein relate to electronic learning systems and methods, and more particularly to systems and methods for applications that interact with or run within an electronic learning platform.

### INTRODUCTION

Electronic learning (also called e-Learning or eLearning) generally refers to education or learning where users (e.g. learners, instructors, administrative staff) engage in education related activities using computers and other computing devices. For examples, learners may enroll or participate in a course or program of study offered by an educational institution (e.g. a college, university or grade school) through a web interface that is accessible over the Internet. Similarly, learners may receive assignments electronically, participate in group work and projects by collaborating online, and be graded based on assignments and examinations that are submitted using an electronic drop box.

Electronic learning is not limited to use by educational institutions, however, and may also be used in governments or in corporate environments. For example, employees at a regional branch office of a particular company may use electronic learning to participate in a training course offered by their company's head office without ever physically leaving the branch office.

Electronic learning can also be an individual activity with no institution driving the learning. For example, individuals may participate in self-directed study (e.g. studying an electronic textbook or watching a recorded or live webcast of a lecture) that is not associated with a particular institution or organization.

Electronic learning often occurs without any face-to-face interaction between the users in the educational community. Accordingly, electronic learning overcomes some of the geographic limitations associated with more traditional learning methods, and may eliminate or greatly reduce travel and relocation requirements imposed on users of educational services.

Furthermore, because course materials can be offered and consumed electronically, there are fewer physical restrictions on learning. For example, the number of learners that can be enrolled in a particular course may be practically limitless, as there may be no requirement for physical facilities to house the learners during lectures. Furthermore, learning materials (e.g. handouts, textbooks, etc.) may be provided in electronic formats so that they can be reproduced for a virtually unlimited number of learners. Finally, lectures may be recorded and accessed at varying times (e.g. at different times that are convenient for different users), thus accommodating users with varying schedules, and allowing users to be enrolled in multiple courses that might have a scheduling conflict when offered using traditional techniques.

Electronic learning users may have user accounts in order to engage in education related activities using computers and other computing devices. Electronic learning systems may interact with one or more computing applications or may run one or more computing applications to provide education related activities and exchange data regarding users, course material, statistics and so on. For known systems, an application may interact with an electronic learning system in the context of a user account. That is, known systems may manage user accounts and applications may run based on the user account requesting the application. There is a need for improved systems and methods for managing applications that interact with or run within an electronic learning system.

### SUMMARY

In a first aspect, there is provided a computer implemented method of controlling computing application interactions with an electronic learning platform, wherein the computer comprises a processor and a memory coupled to the processor and configured to store instructions executable by the processor to perform the method comprising: creating a plurality of application accounts for a corresponding plurality of computing applications, wherein each application account identifies a computing application and corresponding permissions and settings for the computing application; receiving a request for a computing application to interact with an electronic learning platform, wherein the electronic learning platform is configured to provide electronic learning services for a plurality of users; determining whether an application account corresponds to the computing application of the request; upon determining that an application account does not corresponds to the computing application of the request, rejecting the requested interaction; upon determining that an application account corresponds to the computing application of the request, determining whether the requested interaction is permitted based the permissions and the settings of the account identifying the respective computing application; upon determining that the requested interaction is not permitted, rejecting the requested interaction; and upon determining that the requested interaction is permitted, authorize the requested interaction.

In accordance with some embodiments, each application account may comprise an application identifier and a key, wherein receiving the request from the computing application comprises receiving an application identifier and a key, and wherein authorizing the request further comprises retrieving the application account identifying the respective computing application using the application identifier, and validating the request by checking the received key against the key of the application account.

In accordance with some embodiments, the permissions of an application account identify zero or more authorized actions, wherein the request identifies a requested action by the computing application and wherein authorizing the requested interaction comprises checking the requested action against the authorized actions of the application account identifying the respective computing application. For example, it may be possible for an application account to exist but not permit the application to take any actions.

In accordance with some embodiments, upon determining that an application account does not corresponds to the computing application of the request, prompting an administrator to create an account for the computing application of the request in order to authorize the requested interaction.

In accordance with some embodiments, the received request for a computing application to interact with an electronic learning platform was initiated by the electronic learning platform. In accordance with some embodiments, the received request for a computing application to interact with an electronic learning platform was initiated by the computing application.

In accordance with some embodiments, the method may further comprise creating a new application account for a computing application by configuring and storing the permissions and the settings for the computing application.

In accordance with some embodiments, the method may further comprise deleting an application account for a computing application such that the respective computing application is no longer permitted to interact with the electronic learning platform without the application account.

In accordance with some embodiments, the method may further comprise updating an application account by modifying the permissions and the settings.

In accordance with some embodiments, the method may further comprise generating an application environment for the electronic learning platform based on a subset of computing applications of the plurality of computing applications and wherein each application account for the subset of computing applications identifies the application environment.

In another aspect, embodiments described herein may provide a system for managing applications relating to an electronic learning platform comprising: an application interface comprising a processor and a memory coupled to the processor and configured to store instructions executable by the processor to manage a plurality of application accounts for a corresponding plurality of computing applications, wherein each application account identifies a computing application and corresponding permissions and settings for the computing application; an electronic learning platform configured to provide electronic learning services for a plurality of users; wherein the application interface permits a computing application of the plurality of computing applications to interact with the electronic learning platform based on the permissions and the settings of the application account identifying the respective computing application.

In accordance with some embodiments, the application interface may be configured to create a new application account for a computing application by configuring and storing the permissions and the settings for the computing application.

In accordance with some embodiments, the application interface is configured to delete an application account for a computing application such that the respective computing application is no longer permitted to interact with the electronic learning platform without the application account.

In accordance with some embodiments, the application interface is configured to update an application account by modifying the permissions and the settings.

In accordance with some embodiments, the application interface is configured to generate an application environment for the electronic learning platform based on a subset of computing applications of the plurality of computing applications.

In accordance with some embodiments, the application interface enables a computing application to interact with the electronic learning platform independent of a user account associated with one of the plurality of users.

In accordance with some embodiments, the application account comprises an application identifier and a key used by the application interface to validate the respective application.

In another aspect, embodiments described herein provide a computer-readable storage medium storing one or more sequences of instructions which, when executed by one or more processors, causes the one or more processors to perform a method of controlling computing application interactions with an electronic learning platform, the method comprising: creating a plurality of application accounts for a corresponding plurality of computing applications, wherein each application account identifies a computing application and corresponding permissions and settings for the computing application; receiving a request for a computing application to interact with an electronic learning platform, wherein the electronic learning platform is configured to provide electronic learning services for a plurality of users; determining whether an application account corresponds to the computing application of the request; upon determining that an application account does not corresponds to the computing application of the request, rejecting the requested interaction; and upon determining that an application account corresponds to the computing application of the request, authorizing the requested interaction based the permissions and the settings of the identifying the respective computing application.

### DRAWINGS

Various embodiments will now be described, by way of example only, with reference to the following drawings, in which:

FIG. 1 is a schematic diagram of an electronic learning system for managing applications accounts for an electronic learning system according to some embodiments;

FIG. 2 is schematic diagram of an application interface according to some embodiments;

FIG. 3 is a schematic diagram of an application account record according to some embodiments;

FIG. 4 is a flow diagram of a method for managing application accounts for an electronic learning system according to some embodiments;

FIG. 5 is another flow diagram of a method for managing application accounts for an electronic learning system according to some embodiments; and

FIG. 6 is a schematic diagram of a user interface for managing account according to some embodiments.

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

### DESCRIPTION OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, tablet, UMPC device, and wireless hypermedia device or any other computing device capable of being configured to carry out the methods described herein.

Program code is applied to input data to perform the functions described herein and to generate output information. The output information is applied to one or more output devices. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including as volatile or non-volatile memory provided on optical, magnetic or electronic storage media, such as for example one or more diskettes, compact disks, tapes, chips, and the like. Non-transitory computer-readable media comprise all computer-readable media, with the exception being a transitory, propagating signal. The term “non-transitory” is not intended to exclude computer readable media such as a volatile memory or RAM, where the data stored thereon is only temporarily stored. The computer useable instructions may also be in various forms, including compiled and non-compiled code.

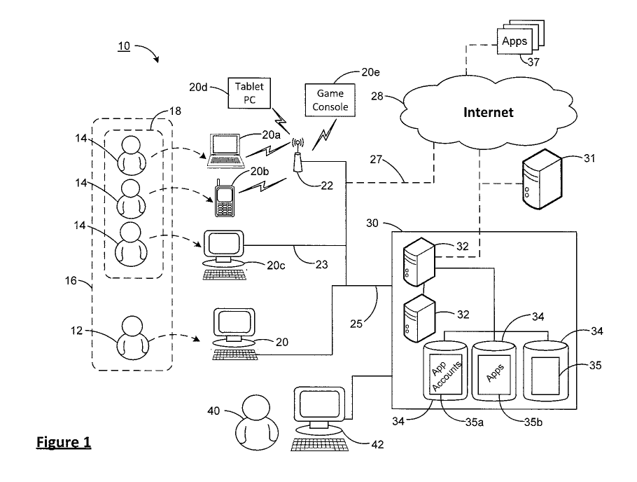

Referring now to FIG. 1, illustrated therein is a system 10 with components configured to manage application accounts according to some embodiments. The system 10 as shown is an electronic learning system or eLearning system. However, in other instances the system 10 may not be limited to electronic learning systems and it may be other types of systems.

System 10 is operable to interact with, launch, invoke, run or execute a computing application 35b, 37 in the context of an application account specific to that application. Applications 35b may be an internal component of an electronic learning provider 30, or applications 37 may be external to the electronic learning provider 30 and connected thereto via a network (e.g. Internet 28). System 10 is operable to create application accounts for corresponding computing applications 37, 35b. Each account identifies a computing application 37, 35b, such as for example via an application identifier, and may also include settings and permissions defining actions permitted by the application. The account may also include a key to authenticate or validate an application 37, 35b when an application 37, 35b requests access to system 10 or when system 10 requests an application 37, 35b.

Prior to interacting with, launching, invoking, running or executing an application 37, 35b, system 10 is operable to receive an application identifier and a key from the application 37, 35b and retrieve a corresponding account (if any) using the application identifier. System 10 is operable to validate the application 37, 35b by checking the received key against the key of the account. System 10 may initiate a request to interact with an application 37, 35b by sending a request to the application 37, 35 for an application identifier and a key. An application 37, 35b may initiate a request to interact with system 10 by sending an application identifier and a key for the application 37, 35b to system 10. This exchange may be implemented as a digital signing process or straight provision via messages, for example. The messages may be non-rewritable for security and authenticity.

Upon receiving the application identifier and key, system 10 is operable to query for the account specific to the application 37, 35b using the application identifier. If no account exists for the application 37, 35b, then system 10 may deny the request and may not interact with, launch, invoke, run or execute the application 37, 35b. In some cases when no account exists for the application 37, 35b, an administrative user may be prompted to create an account for the application 37, 35b. If an account exists for the application 37, 35b then the operation of the application (e.g. actions that may be taken by the application 37, 35b) may be governed by the permissions and settings defined in the associated account. That is, any action to be carried out by the application is validated against the set of permissions in the associated account. The actions may be validated on a batch basis or a rolling basis. For example, an application (e.g. actions that may be taken by may be permitted to input (or write) data (e.g. class enrollment data) to system 10 but may not be permitted to retrieve (or read) data stored in system 10. If a requested action is not permitted by permissions of the account of the requesting application 37, 35b then an error message may be sent to the application 37, 35b and the requested action may be denied. In some cases, if one requested action is not permitted then all actions may not be permitted even if the other actions are permitted by the permissions and settings. In other cases, if one requested action is not permitted and other requested actions are permitted then the permitted actions may be taken by the application (e.g. actions that may be taken by the application 37, 35b. In some cases, if an application 37, 35b requests an action that is not permitted based on the permissions of the account then an administrative user may be prompted to modify the permissions to permit the requested action.

In accordance with some embodiments, system 10 may also manage user accounts for users 14, 12 and may require each user 14, 12 to log into their account in order to access functionality of system 10. A user account may also defined permissions and settings specific to a user 14, 12. An active user 14, 12 may trigger system 10 to launch an application 37, 35b. System 10 is operable to launch an application 37, 35b and validate actions to be taken by the application 37, 35b by overlaying the permissions of the user account for the active user 14, 12 on the permission of the application account for the application 37, 35b. That is, system 10 is operable to validate actions to be taken by the application 37, 35b by checking a combination of the user account permissions and the application account permissions.

The application account is specific to an application 37, 35b and may be applicable to multiple users 14, 12, and in particular, may be applicable to all users that interact with, launch, invoke, run or execute the application 37, 35b. In contrast, a user account is specific to a user 14, 12 and may be applicable to multiple applications 37, 35b, such as all applications 37, 35b that the user 14, 12 interacts with, launches, invokes, runs or executes. For example, for known operating systems, a user 14, 12 may log into an operating system associated with system 10 at the system-level (as opposed to the application-level) through its user account and may interact with, launch, invoke, run or execute an application 37, 35b (e.g. computing programs) through its user account, where the user account governs permissions and settings specific to the user 14, 12 and applicable to all applications 37, 35b that the user 14, 12 interacts with, launches, invokes, runs or executes.

For some systems without application accounts (accounts specific to an application 37, 35b as opposed to a user 14, 12), a user account may be created specifically to permit a user 14, 12 to access a particular application 37, 35b. A user account created to run the particular application 37, 35b may be forgotten when the application 37, 35b is deleted/uninstalled. These forgotten user accounts may need to be cleaned up by system 10 when the application 37, 35b is deleted, such as for example by manually deleting the user account. Forgotten user accounts may be compromised by non-authorized users. A large number of forgotten user accounts may lead to management and security inefficiencies. Further, for some systems (without application specific accounts) user accounts may be deleted which may inadvertently impact the application 37, 35b if the user corresponding to the deleted user account is the only user with access to the application 37, 35b for example. This may effectively make the application 37, 35b non-functional as no user account can access the application (other than the deleted user account) without necessarily realizing such consequences.

In accordance with embodiments described herein, system 10 is operable to manage application accounts for corresponding computing applications 37, 35b that that interact with, launch, invoke, run or execute within system 10. In order for an application 37, 35b to that interact with, launch, invoke, run or execute within system 10 an application account may be required. The application accounts may include permissions and settings that govern operations (e.g. actions taken by applications 37, 35b) of specific applications 37, 35b within system 10.

Using the system 10, one or more users 12, 14 may communicate with an educational service provider 30 to participate in, create, and consume electronic learning services, including educational courses. In some cases, the educational service provider 30 may be part of (or associated with) a traditional “bricks and mortar” educational institution (e.g. a grade school, university or college), another entity that provides educational services (e.g. an online university, a company that specializes in offering training courses, an organization that has a training department, etc.), or may be an independent service provider (e.g. for providing individual electronic learning). Each user 12, 14 of the system 10 may be associated with a user account which may govern access permissions and setting configuration for the user.

It should be understood that a course is not limited to courses offered by formal educational institutions. The course may include any form of learning instruction offered by an entity of any type. For example, the course may be a training seminar at a company for a group of employees or a professional certification program (e.g. PMP, CMA, etc.) with a number of intended participants.

In some embodiments, one or more educational groups can be defined that includes one or more of the users 12, 14. For example, as shown in FIG. 1, the users 12, 14 may be grouped together in an educational group 16 representative of a particular course (e.g. History 101, French 254), with a first user 12 or “instructor” being responsible for organizing and/or teaching the course (e.g. developing lectures, preparing assignments, creating educational content etc.), while the other users 14 or “learners” are consumers of the course content (e.g. users 14 are enrolled in the course).

In some examples, the users 12, 14 may be associated with more than one educational group (e.g. the users 14 may be enrolled in more than one course, a user may be enrolled in one course and be responsible for teaching another course, a user may be responsible for teaching a plurality of courses, and so on).

In some cases, educational sub-groups may also be formed. For example, the users 14 are shown as part of educational sub-group 18. The sub-group 18 may be formed in relation to a particular project or assignment (e.g. sub-group 18 may be a lab group) or based on other criteria. In some embodiments, due to the nature of the electronic learning, the users 14 in a particular sub-group 18 need not physically meet, but may collaborate together using various tools provided by the educational service provider 30.

In some embodiments, other groups 16 and sub-groups 18 could include users 14 that share common interests (e.g. interests in a particular sport), that participate in common activities (e.g. users that are members of a choir or a club), and/or have similar attributes (e.g. users that are male, users under twenty-one years of age, etc.).

Communication between the users 12, 14 and the educational service provider 30 can occur either directly or indirectly using any one or more suitable computing devices. For example, the user 12 may use a computing device 20 having one or more client processors such as a desktop computer that has at least one input device (e.g. a keyboard and a mouse) and at least one output device (e.g. a display screen and speakers).

The computing device 20 can generally be any suitable device for facilitating communication between the users 12, 14 and the educational service provider 30. For example, the computing device 20 could be a laptop 20a wirelessly coupled to an access point 22 (e.g. a wireless router, a cellular communications tower, etc.), a wirelessly enabled personal data assistant (PDA) 20b or smart phone, a terminal 20c, a tablet computer 20d, or a game console 20e operating over a wired connection 23.

The computing devices 20 may be connected to the service provider 30 via any suitable communications channel. For example, the computing devices 20 may communicate to the educational service provider 30 over a local area network (LAN) or intranet, or using an external network (e.g. by using a browser on the computing device 20 to browse to one or more web pages or other electronic files presented over the Internet 28 over a data connection 27). Computing devices 20 may store one or more applications that may interact with or run within system 10.

In some examples, one or more of the users 12, 14 may be required to authenticate their identities in order to communicate with the educational service provider 30. For example, each of the users 12, 14 may be required to input a user identifier such as a login name, and/or a password associated with that user or otherwise identify themselves to gain access to the system 10. The login name and password may be stored in a user account associated with the user 14, 12, where the user account may govern access permissions and setting configurations associated with the user.

In some examples, one or more users (e.g. “guest” users) may be able to access the system without authentication. Such guest users may be provided with limited access, such as the ability to review one or more components of the course to decide whether they would like to participate in the course but without the ability to post comments or upload electronic files.

In some embodiments, the wireless access points 22 may connect to the educational service provider 30 through a data connection 25 established over the LAN or intranet. Alternatively, the wireless access points 22 may be in communication with the educational service provider 30 via the Internet 28 or another external data communications network. For example, one user 14 may use a laptop 20a to browse to a webpage that displays elements of an electronic learning system (e.g. a course page).

Educational service provider 30 may be implemented using servers 32 and data storage devices 34 configured with database(s) or file system(s), or using multiple servers or groups of servers 32 and data storage devices 34 distributed over a wide geographic area and connected via a network (e.g. Internet 28). Educational service provider 30 may reside on any networked computing device including a processor and memory, such as an electronic reading device, a personal computer, workstation, server, portable computer, mobile device, personal digital assistant, laptop, smart phone, WAP phone, an interactive television, video display terminals, gaming consoles, and portable electronic devices or a combination of these. Educational service provider 30 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Educational service provider 30 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like. System 10 may include one or more input devices, such as a keyboard, mouse, camera, touch screen and a microphone, and may also include one or more output devices such as a display screen and a speaker. Educational service provider 30 has a network interface in order to communicate with other components, to serve web pages, and perform other computing applications by connecting to any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Educational service provider 30 may also include an internal network to connect components of the education service provider 30 such as the servers 32 and the data storage devices 34.

The educational service provider 30 generally includes a number of functional components for facilitating the provision of electronic learning services. For example, the educational service provider 30 generally includes one or more processing devices such as servers 32, each having one or more processors. The processors on the servers 32 will be referred to generally as “remote processors” so as to distinguish from client processors found in computing devices (20, 20a-20e). The servers 32 are configured to send information (e.g. electronic files such as web pages) to be displayed on one or more computing devices 20 in association with the electronic learning system 10 (e.g. course information). In some embodiments, a server 32 may be a computing device 20 (e.g. a laptop or personal computer).

The educational service provider 30 also generally includes one or more data storage devices 34 (e.g. memory, etc.) that are in communication with the servers 32, and could include a relational database (such as a SQL database), or other suitable data storage devices. The data storage devices 34 are configured to host data 35 about the courses offered by the service provider (e.g. the course frameworks, educational materials to be consumed by the users 14, records of assessments done by users 14, etc.). The data storage devices 34 may also host applications 35b which are executed by server 32. External applications 37 may also interact with educational service provider 30 which may be temporarily or permanently loaded onto data storage devices 34 and may be executed by server 32.

The data storage devices 34 may also host application accounts 35a for applications 37, 35b that interact with educational service provider 30 or run within educational service provider 30 (or are invoked, executed and so on by educational service provider 30). Each application account may identify a particular computing application 37, 35b and may include permissions and settings governing the operations of the particular application 37, 35b (e.g. actions to be carried out or instructed by the computing application 37, 35b) within the context of the educational service provider 30. The data storage devices 34 may also host computing applications 35b that run within educational service provider 30. The computing application may be any type of software application, application plug-in (e.g. a widget), instant messaging application, mobile device application, e-mail application, online telephony application, java application, web page, web object (e.g. a widget), and so on. Generally, a computing application 37, 35b may include computer software designed to help a user 14, 12 or educational service provider 30 to perform specific tasks, and may also include system software, a utility, middleware and so on. Computing applications may also manage and integrate system 10 or educational service provider 30. System software may serve a computing application, which in turn may serve the user. Examples include enrollment applications, grade applications, attendance applications, testing applications, and so on. Further example applications include assessment applications, social collaboration applications, content creation or consumption applications, gaming applications (educational or otherwise), and so on.

The data storage devices 34 may also store authorization criteria that define what actions may be taken by the users 12, 14, such as user accounts. In some embodiments, the authorization criteria may include at least one security profile associated with at least one role. For example, one role could be defined for users who are primarily responsible for developing an educational course, teaching it, and assessing work product from other users for that course. Users with such a role may have a security profile that allows them to configure various components of the course, post assignments, add assessments, evaluate performance, add content objects, edit content objects and so on.

In some embodiments, some of the authorization criteria may be defined by specific users 40 who may or may not be part of the educational community 16. For example, administrator users 40 may be permitted to administer and/or define global configuration profiles for the system 10, define roles within the system 10, set security profiles associated with the roles, and assign the roles to particular users 12, 14 in the system 10. In some cases, the users 40 may use another computing device (e.g. a desktop computer 42) to accomplish these tasks.

The data storage devices 34 may also be configured to store other information, such as personal information about the users 12, 14 of the system 10, information about which courses the users 14 are enrolled in, roles to which the users 12, 14 are assigned, particular interests of the users 12, 14, content for the courses from users 12, 14 and so on. This other information may also be stored in user accounts.

In some embodiments, external computing applications 37 may interact with educational service provider 30 and users 12, 14, such as external computing applications 37 residing on third party systems. External computing applications 37 may also be launched, invoked, executed and so on by educational service provider 30 and users 12, 14. Accordingly, one or more computing applications 35a may be stored internally within educational service provider 30, one or more computing applications 37 may be stored externally to educational service provider 30 but may interact therewith, or a combination thereof.

As noted herein, data storage devices 34 may host application accounts for applications 35b, 37 that interact with educational service provider 30 or run within educational service provider 30. The application accounts may include authorization criteria that define what actions may be taken by the applications, such as permissions and settings. In some embodiments, the authorization criteria may include at least one security profile associated with at least one role. For example, one role could be defined for applications that are primarily responsible for providing data, such as enrollment data for an educational course. A role may have a security profile that allows an application to configure various components of the course, post enrollment data, receive enrollment data, evaluate performance, add course content and so on.

An example application may be an assessment application, and corresponding permissions and settings may include the ability to assess other applications, assess the application, create assessments, edit assessments, delete assessments, create completed assessments and evaluations, edit completed assessments and evaluations, delete completed assessments and evaluations, create assessment criteria, edit assessment criteria, delete assessment criteria, report on assessments and evaluations, and so on. A further example application may be a social collaboration application, and corresponding permissions and settings may include the ability to create collaboration spaces, edit collaboration spaces, delete collaboration spaces, participate in collaboration, invite other applications to collaboration spaces, remove applications from collaboration spaces, report on activity, and so on. An additional example application may be a content creation or consumption application, and corresponding permissions and settings may include the ability to create content, edit content, delete content, create types of content, edit types of content, delete types of content, create access restrictions on content items, report on activity, and so on. A further example application may be a gaming application (educational or otherwise), and corresponding permissions and settings may include the ability to create games, edit games, delete games, create game sessions, edit game sessions, delete game sessions, and so on.

In some embodiments, some of the application account authorization criteria (e.g. permissions) may be defined by specific users 40 who may or may not be part of the educational community 16. For example, administrator users 40 may be permitted to administer and/or define global configuration profiles for the system 10, define roles within the system 10, set security profiles associated with the roles, create and modify application accounts, and assign the roles to particular applications. In some cases, the users 40 may use another computing device (e.g. a desktop computer 42) to accomplish these tasks.

In some embodiments, the system 10 may also have one or more backup servers 31 that may duplicate some or all of the data 35 stored on the data storage devices 34. The backup servers 31 may be desirable for disaster recovery (e.g. to prevent undesired data loss in the event of an event such as a fire, flooding, or theft). In some embodiments, the backup servers 31 may be directly connected to the educational service provider 30 but located within the system 10 at a different physical location.

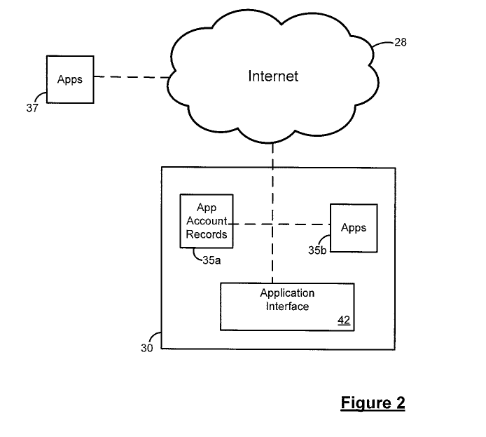

The servers 32 and data storage devices 34 may also provide other electronic learning management tools (e.g. allowing users to add and drop courses, communicate with other users using chat software, etc.), and/or may be in communication with one or more other vendors that provide the tools. An example electronic learning management tools may include a tool for managing application accounts, as will be further discussed in relation to FIG. 2.

Referring now to FIG. 2, there is shown a block diagram of an application interface 42 for managing application accounts in accordance with embodiments described herein. In this example, application interface 42 may reside on data storage device 34 and may be executed by a server 32 of educational service provider 30. In other examples, application interface 42 may be external to educational service provider 30 and interact therewith via a network. For example, application interface 42 may reside on an external data storage device and may be executed by an external server (or server 32). External computing applications 37 may be connected to application interface 42 via Internet 28 or another network. Data storage devices 34 may store applications accounts 35a that correspond to both internal applications 35b and external computing applications 37.

The application interface 42 may include a user interface, a hardware interface, an application programming interface, and so on. Application interface 42 is operable to manage the application accounts 35a for the computing applications 35b, 37. Each application account 35a may identify a computing application 35b, 37 and corresponding permissions and settings for the computing application 35b, 37. The application interface 42 may only permit a computing application 35b, 37 to interact with educational service provider 30 if the respective computing application 35b, 37 has an associated application account 35a. Further, the application interface 42 may only permit a computing application 35b, 37 to interact with educational service provider 30 based on the permissions and the settings of the application account 35a identifying the respective computing application 35b, 37. The permissions may define permitted actions and operations that may be taken by the application 35b, 37. Application interface 42 may only permit a computing application 35b, 37 to carry out an action if included as a permitted action in the permissions and the settings of the application account 35a identifying the respective computing application 35b, 37.

Application interface 42 enables a computing application 35b, 37 to interact with the educational service provider 30 independent of user accounts associated with one of the plurality of users 14, 12, 40. Application interface 42 may also overlay permissions of a user account on permissions of an application account when an active user 14, 12, 40 (corresponding to the user account) initiates execution of the computing application 35b, 37 (corresponding to the application account).

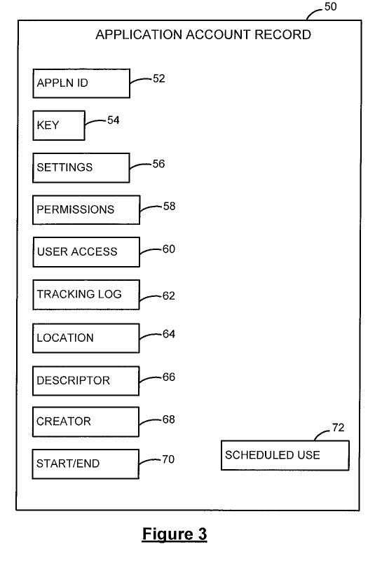

Application interface 42 is operable to create, retrieve and update application account records 35a for computing applications. Application account records 35a will be described in further detail in relation to FIG. 3. Further, application interface 42 is operable to exchange data with computing applications 37, 35a in order to authenticate computing applications 37, 35a and validated actions to be taken by the computing applications 37, 35a.

Prior to interacting with, launching, invoking, running or executing an application 37, 35b, system 10 is operable to receive an application identifier and a key from the application 37, 35b (or other component of system 10) and retrieve a corresponding account (if any) using the application identifier. For example, computing applications 35b, 37 may be required to authenticate their identities when initiating communication with the educational service provider 30. That is, computing applications 35b, 37 may be required to send a message with an application identifier and/or a key associated with that application 35b, 37 (or other form or mechanism of identification) to gain access to the system 10. As another example, system 10 may initiate a request to interact with an application 37, 35b by sending a request to the application 37, 35 for an application identifier and a key. The application identifier and a key may be stored in an application account associated with a computing application 37, 35b, where the application account may govern access permissions and setting configurations associated with the computing applications 37, 35b. Application interface 42 is operable to retrieve the associated account record 35a using the received application identifier. Application interface 42 is operable to validate the application 37, 35b by checking the received key against the key of the corresponding account record 35a. The exchange of application identifier and key may be implemented as a digital signing process or straight provision via messages, for example. The messages may be non-rewritable for security and authenticity.

In some examples, one or more computing applications may be able to access the system 10 without authentication. However, such computing applications may be provided with limited access and permissions. If such computing applications attempt non-permitted actions then authentication may be required by an exchange of application identifier and key along with validation of the application identifier and key. Further, an administrative user 40 may be prompted to create or update an account record 35a if one does not exist for a computing application 37, 35a or if the permissions do not permit a requested action.

Application interface 42 is operable to create a new application account record 35a for a computing application 35b, 37 by configuring and storing the permissions and the settings for the computing application 35b, 37. Further, application interface 42 is configured to delete an application account record 35a for a computing application 35b, 37 such that the respective computing application 35b, 37 is no longer permitted to launch or run within the educational service provider 30 once its application account record 35a is deleted. A new application account 35a may then need to be created if the computing application 35b, 37 is to launch or run within educational service provider 30. Application interface 42 is further configured to update an application account record 35a by modifying the permissions and the settings.

For some known systems, a computing application 37, 35b may interact with an operating system in the context of a user account (as opposed to an application account 35a). The user account is created and managed separately from the application 37, 35a. For example, for a known operating system the user account is associated with the currently logged in user 14, 12, 40 for programs that are launched by that user 14, 12 40, or by the configured user 14, 12, 40 (which could be another user 14, 12 40 or a system-based account like LOCAL_SYSTEM for services and other system level processes). That is, known systems (e.g. Windows, Linux) may manage user accounts separately from applications 37, 35b and applications 37, 35b may run in the context of a user account (as opposed to an application account 35a), where one user account may apply to multiple applications 37, 35b. In contrast, system 10 runs a computing application 37, 35b in the context of an application account 35a which is specific to that computing application 37, 35b (or a family or grouping of computing applications 37, 35b) where the account 35a (and corresponding permissions and settings) may apply to multiple users 14, 12, 40 that launch or run the corresponding application 37, 35b.

In known systems without application accounts 35a, user accounts may be created specifically to run an application 37, 35b. User accounts that were specifically created to run an applications 37, 35b may be forgotten when the application 37, 35b is deleted/uninstalled. These user accounts may need to be manually cleaned up by an administrative user 40 deleting the user accounts for example. For some services, user accounts may have higher than normal privileges so that if such user accounts are forgotten then the potential impact of the user accounts being compromised may be higher. Further, user accounts may be deleted and which may impact the application 37, 35b, effectively making it non-functional if the deleted user account was the only user account with access to the application 37, 35b, without necessarily realizing such consequences.

Embodiments described herein may provide an application interface 42 which treats a computing application 37, 35b similarly to a user in that each application 37, 35b is associated with an application account 35a. That is, an application account 37, 35b is one entity that governs a particular computing application 37, 35b within the context of system 10, and applies to all users 12, 14, 40 that use or interact with the computing application. In some embodiments, there may be one application account 35a for each computing application 37, 35b that interacts with or runs within educational service provider 30. Via the application account 35a, computing application 37, 35b may be assigned appropriate permissions and settings. The settings and permissions may apply to all users 12, 14, 40 that use the computing application 37, 35b, or may work in conjunction with settings and permissions of user accounts. Embodiments described herein may simplify the management of the system 10 as a whole as it may eliminate the need to manage user accounts separately from the application 37, 35b itself.

Further, embodiments described here may allow for fine grained permissions to be assigned to a particular application 37, 35b as per the capabilities of the system 10 and the application 37, 35b in question. For known systems without application accounts, an application 37, 35b may have to run in the context of a user account where the permissions are specific to the user 12, 14, 40 (associated with the user account) as opposed to the application 37, 35b and its capabilities, functions, and uses. Application interface 42 is operable to provide application accounts 35a to govern operation of the corresponding application 37, 35b where the permissions of the application account are tailored specifically to the application 37, 35b (as opposed to being tailored to the user 12, 14, 40 of the application). That is, an application account 35a specific to an application 37, 35b enables fine grained permissions tailored specifically for the application 37, 35b.

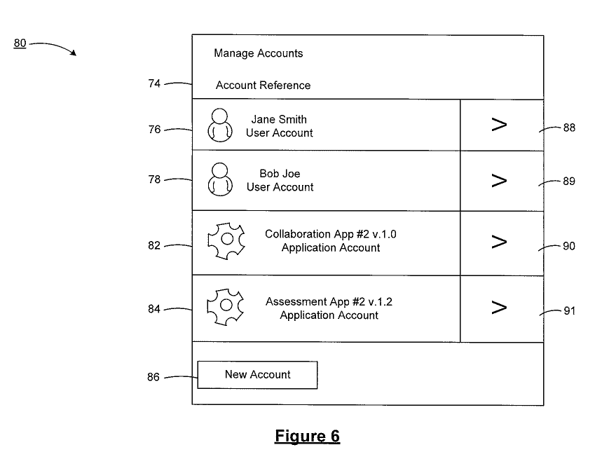

In accordance with embodiments described herein, application interface 42 may provide a user interface for use by users 12, 14, 40 to manage accounts 37a (e.g. create, update, delete). Referring now to FIG. 6, there is shown a schematic diagram of a user interface 80 for managing accounts according to some embodiments. The user interface 80 may be referred as a “Manage Account” tool. System 10 may be configured such that the computing application accounts 35a appear in a Manage Account tools distinctly from users accounts (if any). The application accounts 35a may be distinguished from user accounts, as an application account governs access, permission, and settings for a computing application 35a, in contrast to a user account which governs access, permission, and settings for a user 12, 14 40. Application accounts 35a may be distinguished from user accounts in the Manage Account tool user interface through a different type property or flag. For example, the user interface 80 may include a listing of account references 74 identifying accounts, including user accounts 76, 78 and application accounts 82, 84. For this example, two user accounts 76, 78 are identified with a logo to distinguish from the two application accounts 82, 84 which are identified by another logo. Each account 76, 78, 82, 84 has a corresponding editing tool 88, 89, 90, 91 in order to manage specific features of each account, such as editing permissions and settings for the respective account, deleting the respective account and so on. The editing tool may activate an additional user interface (not shown) for managing the specific features of each account. Further, the user interface 80 may include a new account tool 86 for creating new account for an application.

Computing applications 37, 35b may be associated with courses or other organization units as a role (where the role is defined in the application account 35a) to give the computing application 37, 35b the appropriate settings as determined by the users 12, 14, 40 responsible for administering the system 10 in the same way that they control access for users 12, 14, 40 within the system 10 via roles and user accounts.

When a computing application 37, 35b is deleted from the system 10 (which may or may not be allowed from the Manage Accounts tool) then this deletion action may automatically trigger the removal of associated files and data for the application 37, 35b, including the removal of the associated application account 35a as well as the permissions and settings that were assigned to the application 37, 35b via the application account 35a. This again may simplify the process of managing applications 37, 35b and the accounts 35a under which they operate, and may eliminate the possibility of leaving behind orphaned accounts 35a that represent a larger surface area for attack by malicious users while they are still in the system 10. For example, a user account may be compromised and not noticed if the user accounts are not effectively tracked or are forgotten.

Embodiments described herein may assign permissions and settings directly to the application, via an application account. When an application is removed then this terminates access associated with it (i.e. the application account may be automatically removed). This may eliminate or reduce the chance that there are orphaned accounts in the system 10. Further, embodiments described herein may provide a clear tie between the application and what it is able to do, as the permissions and settings of an application account 35a are specifically tailored to applications 37, 35b and their capabilities (as opposed to users 12, 14).

Referring now to FIG. 3, there is shown a block diagram of an example application account record 50 in accordance with example embodiments. Application interface 42 may be operable to maintain a registry of application account 35a by, for example, maintaining a registry of records 50. The records 50 may be indexed by application identifier 52 for retrieval purposes.

For this example, the application account record 50 may include an application identifier 52 identifying the corresponding application 35b, 37. The application account record 50 may further include a key field 54, a settings field 56, and a permissions field 58. The permissions field 58 may include a listing of permitted actions and operations for the corresponding application 35b, 37. For example, the permissions may permit an application 35b, 37 to write data to system 10 but may not permit an application 35b, 37 to read data from system 10. The application identifier 52 may be system 10 generated identifier. If an application 37, 35b launched or used by a user 14, 12 sends a request to perform an action different than the actions specified in the permissions field 58 then application interface 42 is operable to deny or reject the request. Alternatively, the application interface 42 may prompt an administrator user 40 to modify the permissions field 58 to include the requested action or operation. Action requests may be sent on a rolling basis or in batch. If one requested action is not permitted then the entire batch may be rejected, or only the not permitted actions. Example settings include: configuration settings, default values, connection information for related third-party systems, and so on.

The application account record 50 may also include a user access field 60, which governs user activities within the application 37, 35b. For example, an application 37, 35b may have a number of features and only a subset may be available to some users 12, 14 while all features may be available to an administrative user 40, for example.

An example application may be an assessment application, and corresponding permissions and settings may include the ability to assess other users, assess the current user, create assessments, edit assessments, delete assessments, create completed assessments and evaluations, edit completed assessments and evaluations, delete completed assessments and evaluations, create assessment criteria, edit assessment criteria, delete assessment criteria, report on assessments and evaluations, and so on. A further example application may be a social collaboration application, and corresponding permissions and settings may include the ability to create collaboration spaces, edit collaboration spaces, delete collaboration spaces, participate in collaboration, invite other users to collaboration spaces, remove users from collaboration spaces, report on activity, and so on. An additional example application may be a content creation or consumption application, and corresponding permissions and settings may include the ability to create content, edit content, delete content, create types of content, edit types of content, delete types of content, create access restrictions on content items, report on activity, and so on. A further example application may be a gaming application (educational or otherwise), and corresponding permissions and settings may include the ability to create games, edit games, delete games, create game sessions, edit game sessions, delete game sessions, and so on.

Further, the application account record 50 may include a tracking log 62. The tracking log 62 may contain a record of all operations performed or actions taken by the application, including automated operations and user initiated activities specific to the application. The tracking of activities is done at the application level (e.g. activities performed by a specific application that may span multiple users), as opposed to the user level (e.g. activities performed by a specific user that may span multiple applications). The tracking log may be useful for error checking and audit purposes. For example, the tracking log 62 may track a variety of fields such as user, action performed, date, before values, and after values, for example. The tracking log 62 may track data for the purposes security and activity audits, for example.

The application account record 50 may include a location field 64 identifying the resource the application 37, 35b resides on, and the expected location of the application 37, 35b. The location field 64 may be used to authenticate messages and requests received from the corresponding application 37, 35b by matching the sending address from the message against the location field 64. If a request is coming from another location then the request may be denied as it may be from a malicious unauthorized application imitating the application 37, 35b associated with the account. That is, if the application 37, 35b sends a request from a different location than that specified in the location field 64 then application interface 42 is operable to deny or reject the request. Alternatively, the application interface 42 may prompt an administrator user 40 to modify the location field 64 to include the location the request or message was sent from. Further, the location field 64 may be used by the system 10 when initiating the interaction with the application 37, 35b as it may provide system 10 with an address to send messages and requests. Accordingly, upon receipt of a message from an application 37, 35b, application interface 42 is operable to matching the sender location against the location field 64 of the account record 50 associated with the application 37, 35b as an authentication measure. The location field 64 may also be used for reporting and auditing purposes.

The application account record 50 may also include a descriptor field 66 which provides a description of the application 37, 35b. The description may be human readable. This may help an administrative user 40 managing the records 50 to identify an application 35b, 37 and its functions in order to modify permissions 58 and so on.

The application account record 50 may also include a creator field 68 to identify the creator of the application 35b, 37, such as a company, organization, or individual. The creator field 68 may also refer to the creator of the account record 50. In accordance with some embodiments, the request or other message used to authenticate the application 37, 35b may include a creator identifier which may be validated against the creator field 68. If the application 37, 35b sends a request that contains a different creator then application interface 42 is operable to deny or reject the request. Alternatively, the application interface 42 may prompt an administrator user 40 to modify the creator field 68 to include the creator identifier in the request or message. The creator field 68 may be used for reporting and auditing purposes, for example.

The application account record 50 may also include a timeline field 70 which includes a start date/time and an end date/time defining an activation period for the record 50 and the corresponding application. The record 50 may only be valid during the activation period. For example, the corresponding application 50 may not be permitted to run within system 10 before the start date/time and after the end date/time. If the application 37, 35b sends a request to run on a date outside the timeline field 70 activation period then application interface 42 is operable to deny or reject the request. Alternatively, the application interface 42 may prompt an administrator user 40 to modify the timeline field 70 to include the request date. An account record 50 may be forgotten and the timeline field 70 may provide a mechanism to limit access to the activation period so that a forgotten account 50 that has expired may not be used to compromise the system 10. The timeline field 70 may be used for reporting and auditing purposes, for example.

The application account record 50 may also include a scheduled use field 72 to define a schedule of when the corresponding application 37, 35b may run within or interact with system 10. For example, the scheduled use field 72 may specify that the application 37, 35b may only run on every third Tuesday. If the application 37, 35b sends a request to run on another day then application interface 42 is operable to deny or reject the request. Alternatively, the application interface 42 may prompt an administrator user 40 to modify the scheduled use field 72 to include the request date. The scheduled use field 72 may be used for reporting and auditing purposes, for example.

Application interface 42 may use the key field 54 to authorize an application to run within educational service provider 30, or interact with educational service provider 30. For example, when an application sends a request to connect with educational service provider 30 the application may provide an application identifier and a key. Application interface 42 may retrieve the corresponding application account record 50 by querying for the record 50 a matching application identifier 52, and validate or authenticate the request by checking the provided key against the key field 54. Further, the permissions field 58 and settings field 56 may define the permissions and settings for the application to control the operations of (or actions taken by) the application 37, 35b within the context of the educational service provider 30.

For example, a third party application 37 may input course grades into educational service provider 30 for users 12. Before the third party application 37 can upload grades, the application interface 42 may validate the third party application 37 by retrieving the corresponding application account record 50 (if any) using a received application identifier to find the record 50 with a matching application identifier field 52 (e.g. the records 50 may be indexed by application identifier field 52), and match the received key to the key field 54 of retrieved record 50. If no record 50 with a matching application identifier field 52 exists then the request may be denied. An administrator user 40 may be prompted to create a record 50. Further, if the received key does not match the key field 54 then the request may be denied. The application interface 42 is operable to control operation of and actions taken by a third party application 37, 35b and in particular may specify that the third party application 37 may only provide grades, and may not, for example, provide course content.

As another example, a computing application 37, 35b may be a course enrollment application and may interact with educational service provider 30 to provision enrollment of users 12, 14 in courses. As a further example, a computing application 37, 35b may be an analytic engine monitoring user activities to automate interventions and recommended actions for users 12, 14.

As a further example, an application 37, 35b may automatically provide a quiz, grade the quiz, and upload grades. The permissions field 58 of the associated application account record 50 may specify that the application can access a question bank to compile and offer a quiz to users 12, 14, access an answer key to grade the quiz, and apply the grade to a grade bank for users 12, 14.

Application interface is configured to generate an application environment for the educational service provider 30 based on a subset of computing applications 35b, 37. An application environment therefor may contain a particular combination of applications required for a particular purpose, i.e. uploading course content, editing content, publishing content, and monitoring consumption of content, and particular implementations (e.g. via setting configurations) of each application tailored to the purpose and environment.

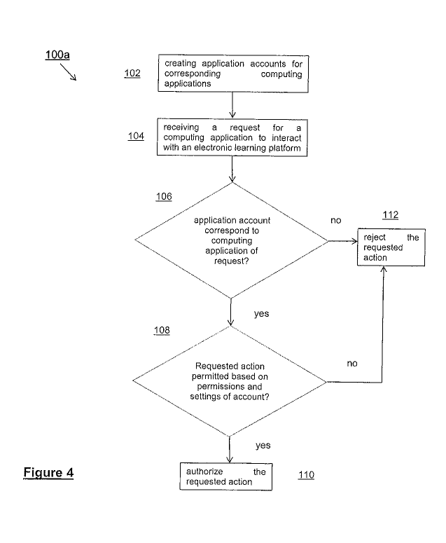

Referring now to FIG. 4, there is shown a flow diagram of an electronic learning method 100a of controlling computing application 37, 35b interactions with an electronic learning platform 30. The method 100a may be implemented by a computer comprising one or more processors and one or more memory coupled to the processor and configured to store instructions executable by the processor to perform the method 100a. As noted herein, electronic learning platform 30 may include an application interface 42 for controlling the launching, running, and so on of a computing application or interactions therewith. The electronic learning platform 30 is configured to provide electronic learning services for a plurality of users.

At 102, application interface 42 is operable to create application accounts 35a for a corresponding number of computing applications. Each application account 35a may include a number of fields, as described in relation of FIG. 3, such as an application identifier and corresponding permissions and settings for the computing application. In some examples, application account comprises an application identifier and a key. Electronic learning platform 30 is configured to provide an interface (such as a user interface, application interface) to receive input data from an administrative user 40 and store the received input data as fields as part of an application account. Application interface 42 is operable to store the application accounts as records 50 in data storage device 34, or another storage device (internal or external). Application interface 42 is operable to index the application account records 50 for retrieval. Application interface 42 is operable to retrieve stored application accounts 35b via an application identifier, or other field. Application interface 42 is operable to update, modify or delete application accounts.

At 104, application interface 42 is operable to receive a request to run, launch, execute, invoke, and so on a computing application 37, 35b, or a request for a computing application 37, 35b to interact with an electronic learning platform 30. The request may be initiated by the computing application 37, 35b, electronic learning platform 30, or a third party platform. The request may include an application identifier and a key, along with other data, such as date and sender address. The request may involve a digital signing process (e.g. for authentication purposes) or a straight provision of messages.

At 106, application interface 42 is operable to determine whether an application account 35a corresponds to the computing application 37, 36b of the request. Application interface is further operable to authorize the request. For example, application interface 42 is operable to authorize the request further by retrieving the application account 35a and record 50 identifying the respective computing application 37, 35b using the application identifier, and validate the request by checking the received key against the key of the application account record 50. That is, application interface 42 is operable to query a registry of application account records 35a using data received in the request or message to launch or run the computing application 37, 35b. For example, the request may include an application identifier and a key and application interface 42 is operable to query a registry of application account records 35a using the received application identifier to determine whether an account record 35a exists with an application identifier field 54 that matches the received application identifier.

If no record 35a exists with a matching application identifier field 54 then application interface is operable to determine that no application account 35a corresponds to the computing application 37, 36b of the request. If a record 35a exists with a matching application identifier field 54 then application interface 42 is operable to determine that the matching application account 35a corresponds to the computing application 37, 36b of the request. Other fields may also be used to query the registry of application accounts 35a to determine whether an account 35a corresponding to the computing application 37, 36b of the request.

Further, application interface 42 is operable to make additional checks to account record 50 to determine whether application account 35a corresponds to the computing application 37, 36b of the request (and to verify or authenticate the request). For example, the request may also contain a key and to verify or authenticate the request, application interface 42 is operable to match the key of the request against a key field 54 of the account record 50 to authenticate the request. If the keys do not match then application interface 42 is operable to determine that an application account 35a does not correspond to the computing application 37, 36b of the request (or prompt for a new key, and so on). As another example, a request may be associated with a sender location and application account is operable to matching the sender location against a location field 64 of the account record 50. These are examples only and other checks may also be performed by application interface 42 to determine whether an application account 35a corresponds to the computing application 37, 36b of the request and to authenticate the request, such as by using a passcode, an electronic cookie, and so on.

At 108, upon determining that an application account 35a corresponds to the computing application 37, 35b of the request, application interface 42 is operable to determine whether the requested interaction is permitted. In accordance with some embodiments, the application interface 42 is operable to determine whether the requested interaction is permitted based the permissions and the settings of the account identifying the respective computing application. As an example, the permissions of an application account record 50 may identify one or more authorized actions. The request may identify a requested action and authorizing the requested interaction may comprise checking the requested action against the authorized actions of the application account identifying the respective computing application.

That is, the application account may 35a contain a permissions field 58 indicating permitted actions and operations for the application 37, 35b. Application interface 42 is operable to check the permissions field 58 to determine whether the requested interaction is included as a permitted action or operation. The permissions field 58 may list non-permitted actions and applications interface 42 is operable to check the permissions field 58 to determine whether the requested action is listed as a non-permitted action. Further checks may also be required to check other fields of the account record 50 to determine whether the requested interaction is permitted. For example, a user 12, 14 may be involved in the requested interaction (e.g. user 12, 14 may be logged in) and application interface 42 is operable to make an additional check to restrictions on user related interactions, such as for example a user access field 60, to determine whether the requested action is permitted for the active user. As a further example, the corresponding account record may include a scheduled use field 72 indicating dates or times that the application 37, 35b is permitted to be used. The application interface 42 is operable to check the schedule use field 72 against the date/time of the request to determine whether the requested use is permitted. These are examples only and other checks are also possible.

At 110, upon determining that the requested interaction is permitted, application interface 42 is operable to authorize the requested interaction.

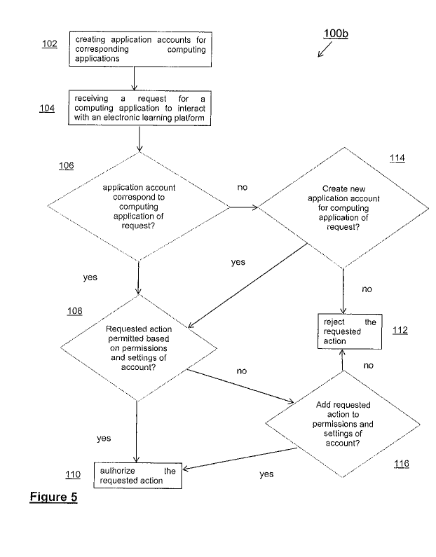

At 112, upon determining that an application account 35a does not corresponds to the computing application 37, 35b of the request, application interface 42 is operable to reject the request to run or interact with the computing application 37, 35b. In accordance with some embodiments, application interface 42 is operable to send a message to an administrative user 40 to prompt creation of an application account 35a for the computing application 37, 35b of the request. Referring now to FIG. 5 there is shown a flow diagram of another method 100b of controlling computing application 37, 35b interactions with an electronic learning platform 30. The method 100b may be implemented by a computer comprising one or more processors and one or more memory coupled to the processor and configured to store instructions executable by the processor to perform the method 100b. The method 100b generally corresponds to the method 100a of FIG. 4 except for the addition of 114 and 116.

At 114, upon determining that an application account 35a does not correspond to the computing application 37, 35b of the request, application interface 42 is operable to trigger transmission of a message or notification to an administrative user 40 to create an application account 35a for the computing application 37, 35b of the request. The administrative user 40 may deny the prompt or may create an account 35a in response to the prompt. The message or notification may contain details regarding the nature of the request (i.e. component that initiated the request and why) to help the administrative user 40 decide whether a new account 35a should be created.

At 116, upon determining that the requested interaction is not permitted, application interface 42 is operable to trigger transmission of a message or notification to an administrative user 40 to modify the application account 35a for the computing application 37, 35b of the request to permit the request interaction (e.g. action, operation). The administrative user 40 may deny the prompt or may modify the account 35a in response to the prompt. The message or notification may contain details regarding the nature of the requested interaction (i.e. component that initiated the request and the purpose of the interaction) to help the administrative user 40 decide whether a new account 35a should be created.

The method 100a, 100b may further involve receiving a request to delete an application account for a computing application. If the account is deleted than there may no longer be an account corresponding to the application 37, 35b and any subsequent request in relation to that application 37, 35b may be rejected at 112. That is, when a corresponding account 35a is deleted the respective computing application is no longer permitted to interact with the electronic learning platform without the application account 35a (e.g. until a new account is created).

The method 100a, 100b may further involve updating an application account by modifying the permissions and the settings. The update may be in response to a prompt to add a requested action, for example. The update may also be to any of the fields of the account record 50.

The method 100a, 100b may further involve generating an application environment for the electronic learning platform based on a subset of computing applications of the plurality of computing applications. Each application account 35a for the subset of computing applications may identify the application environment. One or more users 14, 12 may also be associated with an application environment such that when the user 14, 12 logs into the electronic learning platform they may receive access to the application environment, and subset of the applications of the application environment. All other applications 37, 35b that are not part of the application environment may not be visible to the user.

The scope of the claims should not be limited by the described embodiments and examples but should be given the broadest interpretation consistent with the description as a whole.

1. A computer implemented method of controlling computing application interactions with an electronic learning platform, wherein the computer comprises a processor and a memory coupled to the processor and configured to store instructions executable by the processor to perform the method comprising:
a) creating a plurality of application accounts for a corresponding plurality of computing applications, wherein each application account identifies a computing application and corresponding permissions and settings for the computing application;
b) receiving a request for a computing application to interact with an electronic learning platform, wherein the electronic learning platform is configured to provide electronic learning services for a plurality of users;
c) determining whether an application account corresponds to the computing application of the request;
d) upon determining that an application account does not corresponds to the computing application of the request, rejecting the requested interaction;
e) upon determining that an application account corresponds to the computing application of the request, determining whether the requested interaction is permitted based the permissions and the settings of the account identifying the respective computing application;
f) upon determining that the requested interaction is not permitted, rejecting the requested interaction; and
g) upon determining that the requested interaction is permitted, authorize the requested interaction.

2. The method of claim 1, wherein each application account comprises an application identifier and a key, wherein receiving the request from the computing application comprises receiving an application identifier and a key, and wherein authorizing the request further comprises retrieving the application account identifying the respective computing application using the application identifier, and validating the request by checking the received key against the key of the application account.

3. The method of claim 1, wherein the permissions of an application account identify zero or more authorized actions, wherein the request identifies a requested action by the computing application and wherein authorizing the requested interaction comprises checking the requested action against the authorized actions of the application account identifying the respective computing application.

4. The method of claim 1, wherein upon determining that an application account does not corresponds to the computing application of the request, prompting an administrator to create an account for the computing application of the request in order to authorize the requested interaction.

5. The method of claim 1, wherein the received request for a computing application to interact with an electronic learning platform was initiated by the electronic learning platform.

6. The method of claim 1, wherein the received request for a computing application to interact with an electronic learning platform was initiated by the computing application.

7. The method of claim 1, further comprising creating a new application account for a computing application by configuring and storing the permissions and the settings for the computing application.

8. The method of claim 1, further comprising deleting an application account for a computing application such that the respective computing application is no longer permitted to interact with the electronic learning platform without the application account.

9. The method of claim 1, further comprising updating an application account by modifying the permissions and the settings.

10. The method of claim 1, further comprising generating an application environment for the electronic learning platform based on a subset of computing applications of the plurality of computing applications and wherein each application account for the subset of computing applications identifies the application environment.

11. A system for managing applications relating to an electronic learning platform comprising:
a) an application interface comprising a processor and a memory coupled to the processor and configured to store instructions executable by the processor to manage a plurality of application accounts for a corresponding plurality of computing applications, wherein each application account identifies a computing application and corresponding permissions and settings for the computing application;
b) an electronic learning platform configured to provide electronic learning services for a plurality of users;
wherein the application interface is configured to receive a request for a computing application to interact with the electronic learning platform, determine that an application account corresponds to the computing application of the request, and determine that the requested interaction is permitted based on the permissions and the settings of the application account corresponding to the computing application of the request.

12. The system of claim 11, wherein the application interface is configured to receive an additional request for an additional computing application to interact with the electronic learning platform, determine that an application account does not correspond to the additional computing application of the additional request, and deny the requested interaction.

13. The system of claim 11, wherein the application interface is configured to receive an additional request for an additional computing application to interact with the electronic learning platform, determine that an application account corresponds to the additional computing application of the additional request, determine that the requested interaction is not permitted based on the permissions and the settings of the application account corresponding to the additional computing application of the additional request, and deny the requested interaction.

14. The system of claim 11, wherein the application interface is configured to create a new application account for a computing application by configuring and storing the permissions and the settings for the computing application.

15. The system of claim 11, wherein the application interface is configured to delete an application account for a computing application such that the respective computing application is no longer permitted to interact with the electronic learning platform without the application account.

16. The system of claim 11, wherein the application interface is configured to update an application account by modifying the permissions and the settings.

17. The system of claim 11, wherein the application interface is configured to generate an application environment for the electronic learning platform based on a subset of computing applications of the plurality of computing applications.

18. The system of claim 11, wherein the application interface enables a computing application to interact with the electronic learning platform independent of a user account associated with one of the plurality of users.

19. The system of claim 11, wherein the application account comprises an application identifier and a key used by the application interface to validate the respective application.

20. A computer-readable storage medium storing one or more sequences of instructions which, when executed by one or more processors, causes the one or more processors to perform a method of controlling computing application interactions with an electronic learning platform, the method comprising:
a) creating a plurality of application accounts for a corresponding plurality of computing applications, wherein each application account identifies a computing application and corresponding permissions and settings for the computing application;
b) receiving a request for a computing application to interact with an electronic learning platform, wherein the electronic learning platform is configured to provide electronic learning services for a plurality of users;
c) determining whether an application account corresponds to the computing application of the request;
d) upon determining that an application account does not corresponds to the computing application of the request, rejecting the requested interaction; and
e) upon determining that an application account corresponds to the computing application of the request, authorizing the requested interaction based the permissions and the settings of the identifying the respective computing application.
